(19) United States
(12) Patent Application Publication
(10) Pub. No.: US 2014/0348611 A1
(43) Pub. Date: Nov. 27, 2014

(54) Dual Actuated Nut And/Or Bolt Head With Reversed Thinned Jackscrews And Washer/Nut Castle Interlock

(71) Applicant: John D. Davis, Las Vegas, NV (US)

(72) Inventor: John D. Davis, Las Vegas, NV (US)

(21) Appl. No.: 14/283,198

(22) Filed: May 20, 2014

Related U.S. Application Data
(63) Continuation-in-part of application No. 13/898,674, filed on May 21, 2013.

(51) Int. Cl. F16B 39/12

(52) U.S. Cl. CPC F16B 39/12
USPC 411/214

(57) ABSTRACT

A jackscrew nut and/or bolt head assembly includes a bottom washer that is interlocked via circumferentially arrayed castle extensions and recesses. Spherical faces at the washer top are thereby held in alignment with corresponding spherical jackscrew bottoms, which assures evenly distributed contact pressures during out of angle elastic jackscrew displacement during jackscrew loading. The bottom washer interlock may provide further for a transfer of a primary pre tightening torque exerted onto the main body of the nut and/or bolt head via a tool that concurrently accesses all jackscrew heads extending above the main body. The assembly may be initially tightened via the primary torque whereby secondary jackscrew actuation and displacement is greatly reduced. The jackscrews are thinned in reverse for maximum contact area at their spherical bottoms.

### CONTINUATION IN PART

The present invention is a Continuation in Part of the U.S. patent application Ser. No. 13/898,674 titled “Dual Actuated Jackscrew Nut And/Or Bolt Head” filed on May 21, 2013 of the same inventor.

### FIELD OF INVENTION

The present invention relates to jackscrew nuts and bolt heads.

### BACKGROUND OF INVENTION

Jackscrew nuts and bolt heads circumvent the need for high power torque wrenches, especially with larger bolt diameters. Instead of having to tighten one nut or bolt head with high torque and big tool to bring the respective central thread connection to the required load, a number of circular arrayed jackscrews that are screwed in the nut and/or bolt head are sequentially tightened with comparatively low torques requiring only comparatively small tools. The jackscrews thereby lift off and the nut and/or bolt head from their flange position as is well known in the art.

The single actuation of nut and/or bolt head via jackscrews commonly requires extensive repetitive actuation of the individual jackscrews to induce the overall loading lift off. A substantial portion of that overall loading lift off is commonly needed in comparatively low overall nut and/or bolt load range, which would require relatively low tightening torque on the nut and/or bolt head. This in turn would substantially reduce overall jackscrew actuations. Therefore, there exists a need for a jackscrew nut and/or bolt head that provides for a dual actuation such that low load displacement may be accomplished by tightening the nut and/or bolt head directly and such that the final loading may be provided via the jackscrews. The present invention addresses this need.

During final tightening of jackscrews, contact pressures between the jackscrew bottom and the opposing washer or flange commonly cause galing between the surfaces. This substantially increases friction in the interface. In addition to load related elastic deformations and due to necessary loose thread connections, the jackscrews are forced out of their natural assembly direction. This causes edge contact of the jackscrew bottom, which increases local peak stresses and galing even more. In the prior art it has been attempted to reduce this issue by making the jackscrew bottom slightly spherical. Nevertheless a spherical surface pressing against a planar surface causes again high peak stresses and galing. Therefore, there exists a need for a nut and/or bolt head jackscrew assembly incorporating a load washer with spherical faces that are held in alignment with spherical jackscrew bottoms. The present invention addresses also this need.

Jackscrew nuts and/or bolt heads commonly need to be utilized at radially tight locations, while at the same time providing pre tightening and an interlocking between the nut and/or bolt head and a washer. The present invention addresses also this need.

### SUMMARY

A jackscrew nut and/or bolt head assembly includes a circumferentially and radially interlocked load washer. Spherical faces at the washer top are thereby held in alignment with corresponding spherical jackscrew bottoms. The spherical-to-spherical jackscrew-washer interface assures evenly distributed contact pressures during out of angle elastic jackscrew displacement and minimizes galing.

The circumferential and radial interlocked load washer provides further for a transfer of a primary torque exerted onto the main body of the nut and/or bolt head via an assembly torque access, which may be a standardized outside spline such as well known triple square, twelve spline or the like. The assembly torque access may be incorporated at the top and/or circumference of the nut and/or bolt head. In case it is incorporated at the circumference, the assembly torque access may also be incorporated into the load washer in a fashion such that load washer and nut and/or bolt head may have the primary torque concurrently applied.

The washer interlock may be provided by a castle shaped top of the load washer that interlocks with corresponding recesses at the bottom of the nut and/or bolt head. In addition, the jackscrews may be reversed thinned with a bottom diameter larger than a central thread diameter, which in turn is larger than a jackscrew top diameter. The top diameter may be provided by a top shaft that is guided in a corresponding top guide hole of the nut and/or bolt head. At the same time a bottom guide shaft of the jackscrew is guided in bottom guide hole within either a washer castle or the nut and/or bolt head. This keeps the jackscrew thread free of tilting forces that may occur during elastic deformation of the nut and/or bolt head during tightening. Also, the larger bottom diameter maximizes area contact and minimizes contact pressures with the load washer. The jackscrew heads may have radial recesses for applying torque to the jackscrew. Circumferential portions of the jackscrew heads may have a continuous diameter such the circular arrayed jackscrew heads may be together accessed by pre tightening tool. An overall outside diameter of the nut and/or bolt head may be kept to a minimum while providing a more centralized tool access to the individual jackscrew heads. This may be of particular advantage in tight applications of the present invention.

### BRIEF DESCRIPTION OF THE FIGURES

FIG. 1 is a front perspective view of a first embodiment of the invention in a nut configuration.

FIG. 2 is a partial cut view of FIG. 1.

FIG. 3 is a bottom perspective view of a partial assembly of FIG. 1.

FIG. 4 is a front perspective view of a second embodiment of the invention in a nut configuration

FIG. 5 is a front perspective partial cut view of a third embodiment of the invention in a bolt head configuration.

FIG. 6A is front perspective partial cut view of a fourth embodiment of the invention in nut configuration with a pre tightening tool above .

FIG. 6B shows a jackscrew of the fourth embodiment.

### DETAILED DESCRIPTION

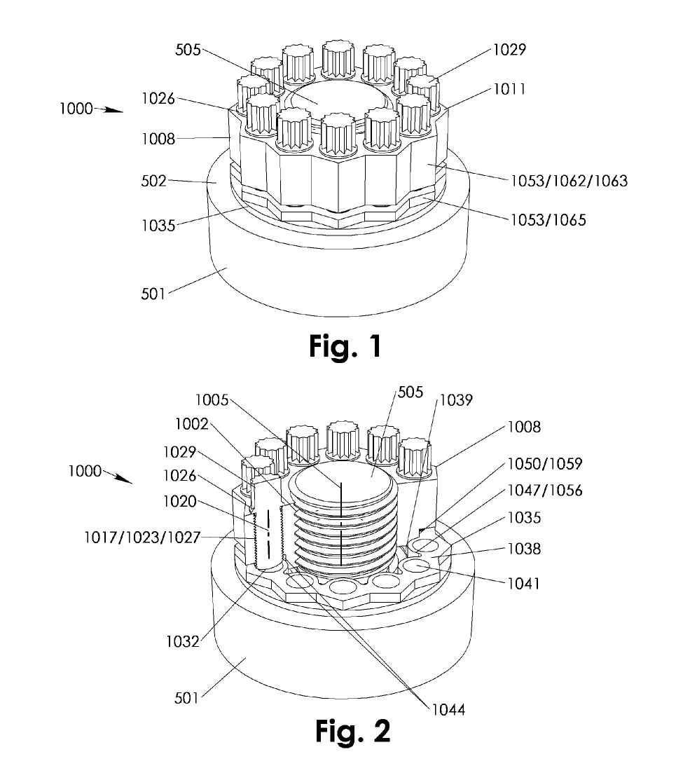

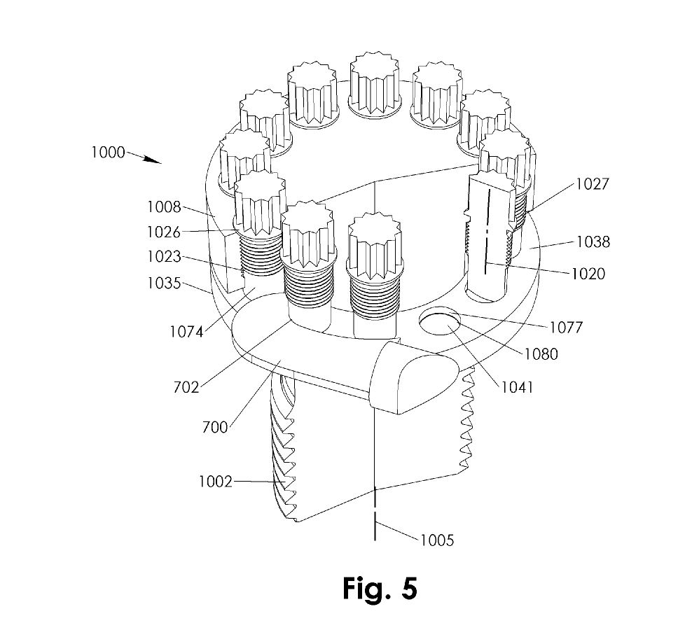

According to a first embodiment of the invention and referring to FIGS. 1-3 a jackscrew tightening assembly 1000 may feature a central thread 1002 with a thread axis 1005. In case of the jackscrew tightening assembly 1000 being a nut, the central thread 1002 may be an internal thread. In case of the jackscrew tightening assembly 1000 being a bolt head, the central thread 1002 may be an external thread as shown in FIG. 5. Parts of the jackscrew tightening assembly 1000 are a main body 1008, jackscrews 1026, a load washer 1035 and a washer interlock 1044. The main body 1008 is extending radial outward with respect to the central thread 1002 as is well known for jackscrew nuts and/or bolts. The main body 1008 has a main top 1011, a main bottom 1014 that is opposite the main top 1011 in axial direction with respect to the central thread axis 1005, through holes 1017 with a through hole axis 1020 that is in an offset to the central thread axis 1005, and a secondary thread 1023 at least along a portion of the through hole 1017. The jackscrews 1026 are extending through respective through holes 1017, and engaging via their jackscrew threads 1027 with the respective secondary threads 1023. The jackscrews 1026 have jackscrew heads 1029 facing away from the main bottom 1014 and spherical bottoms 1032 facing away from the main top 1011. The jackscrews 1026 are preferably arrayed in a number around the central thread 1002 such that upon even tightening of all jackscrews 1026 the axial sum of all their individually exerted axial loads is transferred onto the central thread 1002 in a balanced fashion via the main body 1008 as may be well appreciated by anyone skilled in the art.

The load washer 1035 is adjacent the main bottom 1014 and surrounding the central thread 1002. The load washer 1035 has a washer top 1038 that is facing the main bottom 1014 and a number of spherical faces 1041 that are formed into the washer top 1038. The spherical faces 1041 are matching their respective spherical bottoms 1032 and are in substantial axial alignment with them and rotationally symmetric with respect to the central thread axis 1005. The load washer 1035 is at least circumferentially but preferably also radial held with the main body 1008 via a washer interlock 1044 that includes a first interlock feature 1047 provided by the load washer 1035 and a second interlock feature 1050 that is at least circumferentially but preferably also radial mating the first interlock feature 1047 and that is part of the main body 1008 such that the spherical faces 1041 are held in alignment with respective spherical bottoms 1032. The first interlock feature 1047 may be an internal spline that is axially extending through a central through hole 1039 of the load washer 1035. The second interlock feature 1050 may be an external spline axially extending from the main bottom 1014. According to FIGS. 1, 2, the second interlock feature 1050 may be a body contour 1062 axially extending from the main bottom 1014 towards the main top 1011 and the first interlock feature may be one or more protrusions axially extending above the washer top 1038.

Further part of the jackscrew tightening assembly 1000 may be an assembly torque access 1053 via which a primary torque may be externally applied to the jackscrew tightening assembly 1000. The assembly torque access may be part of at least one of the main body 1008 and the load washer 1035 such that the primary torque that is applied to at least one of the main body 1008 and the load washer 1035 is also applied via the washer interlock 1044 to one other of the main body 1008 and the load washer 1035 while the spherical bottoms 1032 remain in substantial axial alignment with their respective spherical faces 1041. The assembly torque access 1053 may be a body outside contour 1063 that at least in part corresponds to a well known twelve spline, triple square standard or the like. The body outside contour may also serve as the second interlock feature 1050. Part of the assembly torque access 1053 may also be a load washer contour 1065 that is axially substantially collinear with the body outside contour 1063 such that the primary torque may be concurrently applied to both the main body 1008 and the load washer 1035 with the same tool as may well appreciated by anyone skilled in the art.

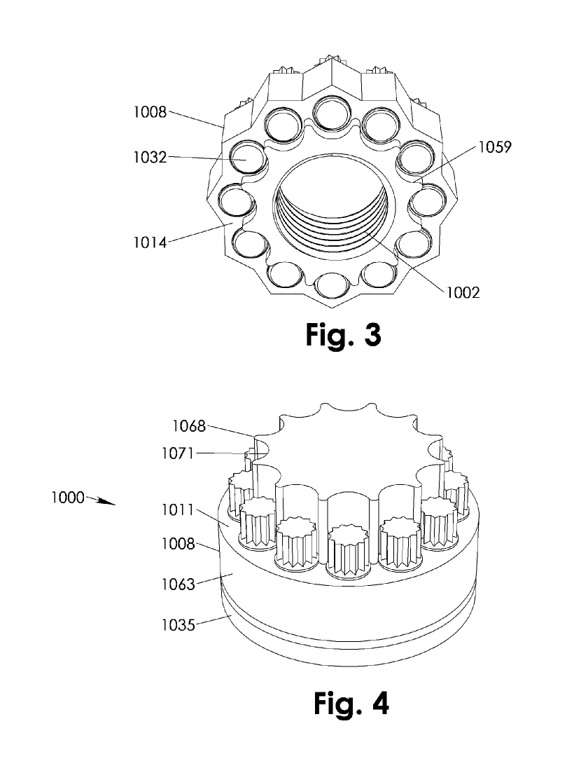

According to FIG. 3, the assembly torque access 1053 may be a body top spline 1068 protruding from the main top 1011. The body top spline 1068 may have jackscrew access recesses 1071 that are radial recessed into it such that the jackscrew heads 1029 are accessible while the body top spline 1068 radial extends in between the jackscrew heads 1029.

Referring to FIG. 5, the main body 1008 and the load washer 1035 may be circumferentially and radial held together via interlock shafts 1074 of the jackscrews 1026 engaging with receptacles 1077 formed into the load washer 1035. Receptacle disks 1080 featuring the spherical faces 1041 may be placed inside and preferably at the bottom of the receptacles 1077. Their small size provides for a cost effective fabrication of them with superior hardness of at least their spherical faces 1041, which may further reduce risk of galing in the interface as may be well appreciated by anyone skilled in the art. At the same time, the load washer 1035 may be fabricated from a less hard and brittle material making it less susceptible to cracking due to out of balance peak loading from the jackscrews 1026 as may also be well appreciated by anyone skilled in the art.

The interlock shafts 1074 may be accessed via the axial gap between the main body 1008 and the load washer 1035 by a hook tool 700 having a hook 702 corresponding to the diameter of the interlock shafts 1074. By use of the hook tool, the primary torque may be applied for initially tightening the main body 1008.

The hook tool 700 provides torque transfer with only partial circumferential access to the main body 1008, which may be advantages in tight locations.

At least one of the jackscrews 1026, the load washer 1035, the main body and the receptacle disks 1080 may be permanently magnetic to assist in keeping the jackscrew tightening assembly 1000 together during its installation and handling. The through hole axes 1020 may be in an angle to the central thread axis 1005 such that the jackscrew heads 1029 are closer to the central thread axis 1005 than the spherical bottoms 1032. This may advantageously provide for a more centralized access to the jackscrew heads 1029 with a tightening tool, while at the same time keeping the most outward diameter of the main body 1008 to a minimum.

In case the load washer 1035 is configured as a well known lock washer with one directional serrations on its bottom or other features preventing the load washer 1035 from being rotated in loosening direction of the main body 1008, the jackscrews 1026 may be loosened to the extent that the jackscrew shafts 1074 disengage from the receptacles 1077 and the main body 1035 rests directly on the washer top 1038 prior to loosening the main body 1008. That way, the locking load washer 1035 may remain stationary while the main body 1035 slides on the washer top 1038. To provide still a gap for hook tool 700 access, the main body 1008 may have a central circular rim extending downward from the main bottom 1014.

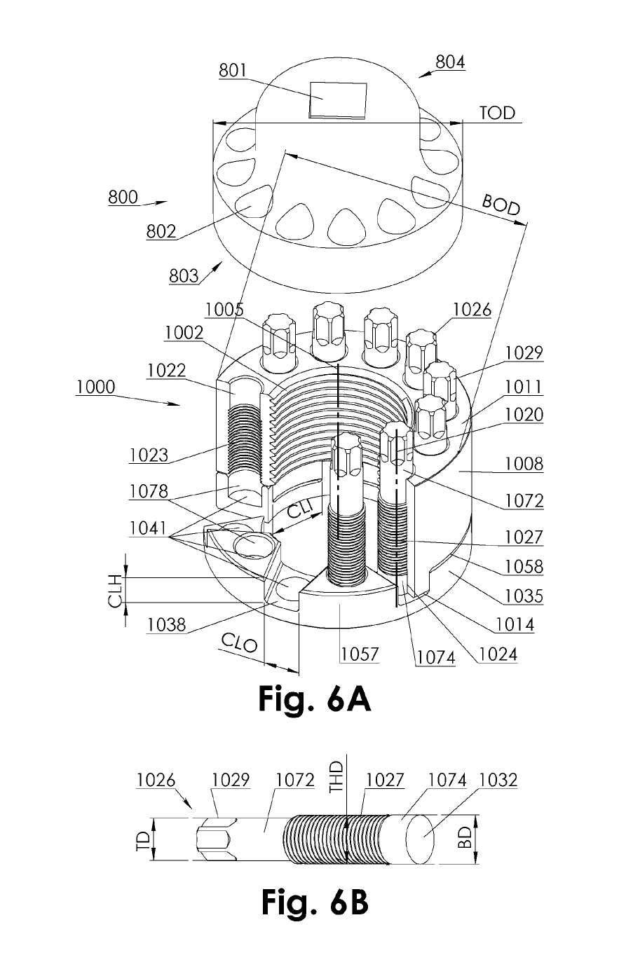

Referring to FIGS. 6A and 6B, in a fourth embodiment of the invention the main body 1008 features top guide holes 1022 that are extending from the main top 1011 concentric with respect to their through hole axes 1020. The secondary threads 1023 are adjacent and below the top guide holes 1022 and concentric with respect to their respective top guide hole 1022. Recessed into the main bottom 1014 are a number of castle recesses 1058 and preferably circumferentially evenly arrayed. Bottom guide holes 1024 are extending from the main bottom 1014 and are also concentric with their respective top guide holes 1022.

The jackscrews of the fourth embodiment have preferably each a top guide shaft 1072 in addition to the bottom guide shaft 1074. Each top guide shaft 1072 is adjacent the jackscrew head 1029 and in between the jackscrew head 1029 and the spherical bottom 1032. The top guide shafts 1072 are guided in respective top guide holes 1022. The load washer 1035 has a number of castle extensions 1057 that extend above the washer top 1038. Castle guide holes 1078 are recessed into the castle extensions 1057 and have spherical faces 1041 formed at their bottom preferably horizontally leveled with the spherical faces 1041 that are formed into the washer top 1038. While the load washer 1035 is in mating contact with the main body 1008, the castle extensions 1057 are interlocking with the castle recesses 1058 axially with respect to the central thread axis 1005. The bottom guide shafts 1074 are preferably guided circumferentially alternating in either the bottom guide holes 1024 or the castle guide holes 1078.

The bottom guide shaft 1074 has a bottom diameter BD that is preferably larger than the jackscrew thread 1027 diameter THD. The top guide shaft 1072 has a top diameter TD that is smaller than the jackscrew thread 1027 diameter THD. The jackscrew heads 1029 may have circumferentially continuous circle portions that are circumferentially interposed with a radial torque access recess. This provides on one hand torque access to individual jackscrews 1026 with correspondingly shaped nuts as is well known in the art. On the other hand, the jackscrews 1026 may be concurrently accessed with a jackscrew assembly tightening tool 800 that has an array of jackscrew head access holes 802 on its tool bottom 803. The jackscrew head access holes 802 are preferably circumferentially arrayed and are matching the jackscrew head 1029 pattern on above the main top 1011. The jackscrew head access holes 802 are close to an outer tool diameter TOD that is preferably smaller than an outer main body diameter BOD. This greatly improves access clearance especially in tight situations, which is made possible due to the even load transfer over a large number of jackscrew heads 1029 and their top guide shafts 1072 that hold the jackscrew heads 1029 rigid against out of axis bending, which may be well appreciated by anyone skilled in the art. A tool access 801 on the tool top 804 may be a square hole for coupling with a hydraulic torque wrench as is well known in the art.

During tightening of the jackscrews 1029 the main body 1008 may come under load and elastically deflect radially outward at the main bottom 1014. To keep the castle guide holes 1078 raidally aligned with top guide holes 1022 in that case, a castle spacing between adjacent castle extensions 1057 may have an outer castle spacing CLO that is less than an inner castle spacing CLI. In that way, the castle recesses 1058 are radially opposed by the castle extensions 1057 while the main bottom 1014 may elastically deform in direction away from the central thread axis 1005.

In the fourth embodiment, the jackscrews 1029 are screwed in from the main bottom 1014 and from the castle recesses 1058. The load washer 1035 is than mated with the main body 1008 and the spherical bottoms 1032 brought into contact with spherical faces 1041. Main body 1008 and load washer 1035 are together screwed on and/or in at their assembly location. Then the pre tightening tool 800 may be coupled with the jackscrew tightening assembly 1000 by mating its jackscrew head access holes 802 with the jackscrew heads 1029. The pre tightening tool 800 may be coupled to a hydraulic torque wrench via its tool access 801 and a pre tightening torque conveniently applied to the main body 1008 via the jackscrew heads 1029. The top guide shafts 1072 assist thereby to transfer the pre tightening force onto the main body 1008. After removing the pre tightening tool 800, the individual jackscrew heads 1029 may be accessed to bring the jackscrew tightening assembly 1000 up to final loading. Loosening of it may be performed in reverse as may be clear to anyone skilled in the art.

Accordingly, the scope of the Figures and the Specification above is set forth by the following claims and their legal equivalent:

What is claimed is:

1. A jackscrew tightening assembly comprising:
a. a central thread with a central thread axis;
b. a main body radially outward extending with respect to said central thread, said main body comprising:
i. a main top;
ii. a main bottom that is opposite said main top in axial direction with respect to said central thread axis;
iii. a top guide hole that is extending from said main top with a through hole axis being in an offset to said central thread axis;
iv. a secondary thread that is adjacent and below said top guide hole and concentric with respect to said top guide hole;
v. a castle recess recessed in said main bottom;
vi. a bottom guide hole that is extending from said main bottom concentric with respect to said top guide hole
c. a jackscrew comprising:
i. a jackscrew head that is facing away from said main bottom;
ii. a spherical bottom that is facing away from said main top;
iii. a top guide shaft that is adjacent said jackscrew head and in between said jackscrew head and said spherical bottom and that is guided in said top guide hole;
iv. a bottom guide shaft that is adjacent said spherical bottom and in between said jackscrew head and said spherical bottom;
d. a load washer that is adjacent to said main bottom and that is surrounding said central thread, said bottom washer comprising:
i. a washer top that is facing said main bottom;
ii. a castle extension that is extending above said washer top;
iii. a castle guide hole recessed into said castle extension;
iv. a spherical face that is formed into at least one of said washer top and said castle guide hole and that is in substantial axial alignment with said spherical bottom with respect to said central thread axis and that is matching said spherical bottom; and
wherein said bottom guide shaft is guided in at least one of said bottom guide hole and said castle guide hole while said castle extension is interlocking with said castle recess axially with respect to said central thread axis.

2. The jackscrew tightening assembly of claim 1 being a nut and said central thread being an internal thread.

3. The jackscrew tightening assembly of claim 1 being a bolt and said central thread being an external thread.

4. The jackscrew tightening assembly of claim 1, wherein said bottom guide shaft comprises a bottom diameter that is larger than a jackscrew thread diameter, and wherein said top guide shaft comprises a top diameter that is smaller than said jackscrew thread diameter.

5. The jackscrew tightening assembly of claim 1, wherein said jackscrew head comprises a circumferentially continuous circle portion that is circumferentially interposed with a radial torque access recess.

6. The jackscrew tightening assembly of claim 1, wherein a castle spacing between adjacent ones of said castle extension comprises an outer castle spacing that is less than an inner castle spacing such that said castle recess is radially opposed by said castle extension while said main bottom is elastically deformed in direction away from said central thread axis.

7. A jackscrew comprising:
a. a jackscrew head;
b. a spherical jackscrew bottom;
c. a bottom guide shaft that is in between said jackscrew head and said jackscrew bottom and that is adjacent said jackscrew bottom, said bottom guide shaft comprising a bottom diameter;
d. a central thread that is adjacent said bottom guide shaft, that is concentric with respect to said bottom guide shaft and that comprises a thread diameter that is smaller than said bottom diameter;
e. a top guide shaft that is in between said jackscrew head and said central thread and that is adjacent said jackscrew head, said top guide shaft comprising a top diameter that is smaller than said thread diameter; and
wherein said jackscrew head has an outer head diameter that is up to said top diameter.

8. The jackscrew of claim 7, wherein said jackscrew head comprises a circumferentially continuous circle portion that is circumferentially interposed with a radial torque access recess.

9. A jackscrew assembly tightening tool comprising:
a. a tool body comprising tool top and a tool bottom;
b. an array of jackscrew head access holes on said tool bottom; and
b. a tool access on said tool top.

10. The jackscrew assembly tightening tool of claim 9, wherein said jackscrew head access holes are circumferentially arrayed close to an outer tool diameter and wherein said tool access is central with respect to said outer tool diameter.

11. The jackscrew assembly tightening tool of claim 10, wherein said jackscrew head access holes are matching a jackscrew head pattern of a jackscrew assembly, wherein said jackscrew assembly comprises an outer main body diameter, and wherein said outer tool diameter is smaller than said main body diameter.
